(19) United States
(12) Patent Application Publication
(10) Pub. No.: US 2011/0229686 A1
(43) Pub. Date: Sep. 22, 2011

(54) Reinforced Boards and Other Building Materials

(76) Inventor: Douglas K. Dueker, Jasper, GA (US)

(21) Appl. No.: 12/725,618

(22) Filed: Mar. 17, 2010

(51) Int. Cl. E04B 1/14; B32B 7/00; B32B 21/08; B32B 15/10

(52) U.S. Cl. 428/119

(57) ABSTRACT

A reinforced board, such as a floor joist, band joist, or ceiling joist that, in various embodiments, comprises: (1) a centrally disposed reinforcing member (e.g., a steel reinforcing member having a substantially Z-shaped or U-shaped cross section); and (2) a plurality of lengths of material (e.g., plastic) that are substantially in the form of a rectangular prism. In particular embodiments, the plurality of lengths of material are positioned and attached circumferentially around the reinforcing member so that the resulting structure has a substantially solid, substantially rectangular cross section.

### BACKGROUND

Currently, most decks are made of wood. However, there are several disadvantages associated with using wood to build decks and other structures. For example, although wood has proven to be a suitable, relatively inexpensive decking material, wooden decks tend to fade and splinter over time. Also, out of concern for a decreasing supply of natural resources, many consumers prefer to avoid using wood as a building material. Wood boards can also be relatively heavy and expensive.

Although alternative decking products are currently used, in some cases, for the surfaces of decks, the structural portions of such decks (e.g., the decks' posts, beams, and joists) are still typically made of wood. This is due to challenges in producing a low maintenance product that has the structural integrity to support the alternative deck surfacing products that are available on the market today.

Accordingly, there is a need for new building materials, such as decking materials (e.g., floor, ceiling, and band joists), that are durable, lightweight, inexpensive, and environmentally friendly.

### SUMMARY

A reinforced board, according to various embodiments, has an exterior surface and comprises an elongated structural support that extends longitudinally within an interior of the reinforced board. This elongated structural support comprises: (1) a substantially planar base portion that defines a first plane; and (2) a substantially planar extension portion that is disposed adjacent the base portion and that defines a second plane that is substantially perpendicular to the first plane. The reinforced board further comprises a first length of material (e.g., plastic, fiberglass, or other suitable material) having a substantially rectangular cross section. This first length of material extends longitudinally along a length of the reinforced board and defines: (1) a first, substantially planar exterior surface; and (2) a second, substantially planar exterior surface that is substantially perpendicular to the first exterior surface. In particular embodiments, the first length of plastic material is disposed in a substantially mating relationship with the elongated structural support so that: (A) the first exterior surface of the first length of plastic material is disposed immediately adjacent, and substantially parallel to, the base portion of the structural support; and (B) the second exterior surface of the first length of plastic material is disposed immediately adjacent, and substantially parallel to, the extension portion of the structural support.

A reinforced board, according to particular embodiments, comprises: (1) an elongated structural support that extends longitudinally within an interior portion of the reinforced board; and (2) a plurality of lengths of plastic material (which may, for example, be the same length in dimension) that each have a substantially rectangular cross section and that each extend longitudinally along a particular length of the reinforced board. In particular embodiments, the plurality of lengths of plastic material are at least substantially matingly attached together in at least a substantially circumferential manner about the elongated structural support to form the reinforced board.

### BRIEF DESCRIPTION OF THE DRAWINGS

Having thus described various embodiments of the invention in general terms, reference will now be made to the accompanying drawings, which are not necessarily drawn to scale, and wherein:

FIG. 1A is a side elevation view of a floor joist according to a particular embodiment of the invention.

FIG. 1B is an end view of the floor joist of FIG. 1A.

FIG. 1C is a cross-sectional view of the body portion of the floor joist of FIG. 1A taken about Section 1C-1C.

FIG. 2A is a side elevation view of an end band joist according to a particular embodiment of the invention.

FIG. 2B is a cross-sectional view of the end band joist of FIG. 2A taken about section 2B-2B. This cross section is also a representation of various embodiments of the cross section of the side band joist 15¹ discussed in detail below.

FIG. 3A is a top perspective exploded view of an exemplary decking structure that incorporates the joists of FIGS. 1A-1C and FIGS. 2A-2B.

FIG. 3B is a top perspective view of an assembled version of the decking structure shown in FIG. 3A.

FIG. 4A is a side elevation view of a ceiling joist according to a particular embodiment of the invention.

FIG. 4B is an end view of the ceiling joist of FIG. 4A.

FIG. 4C is a cross-sectional view of the ceiling joist of FIG. 4A taken about cross-section 4C-4C.

FIG. 5 is a partial cross-sectional view of a portion of the decking structure of FIGS. 3A and 3B taken about Section 5-5.

### DETAILED DESCRIPTION OF VARIOUS EMBODIMENTS

Various embodiments will now be described more fully hereinafter with reference to the accompanying drawings, in which various embodiments of the invention are shown. The inventions may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

### First Exemplary Reinforced Board

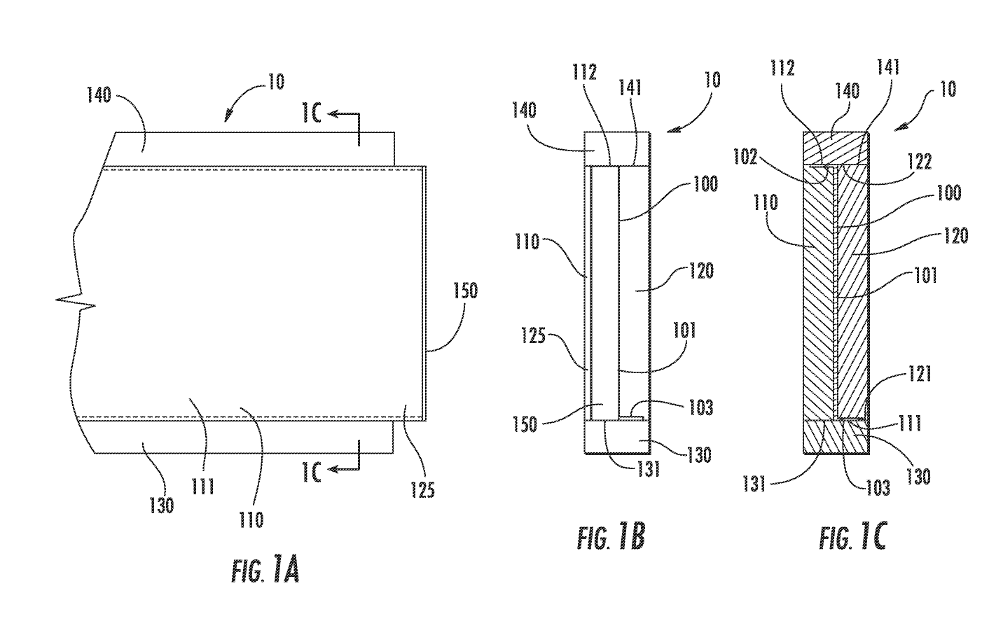

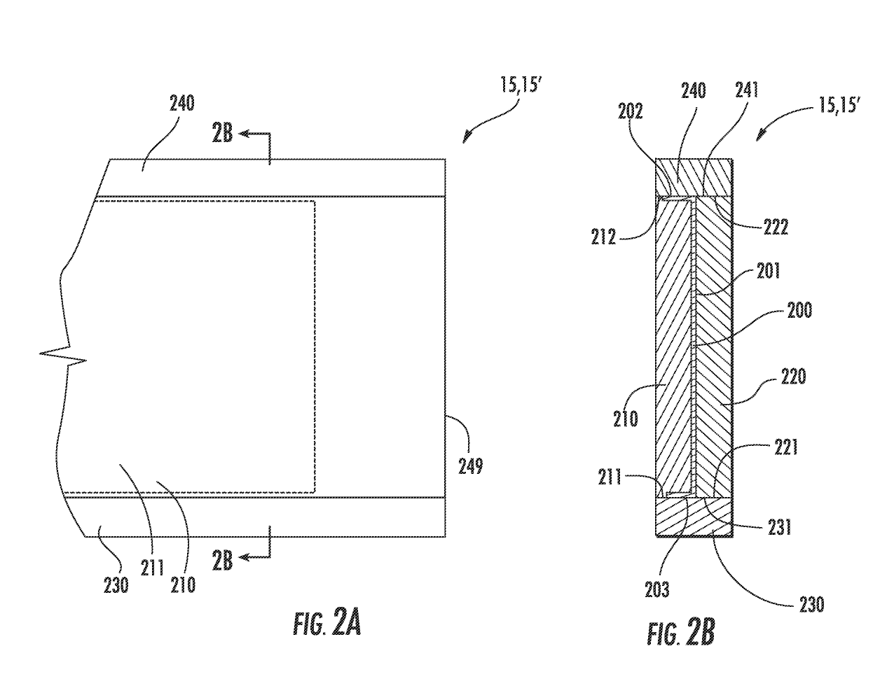

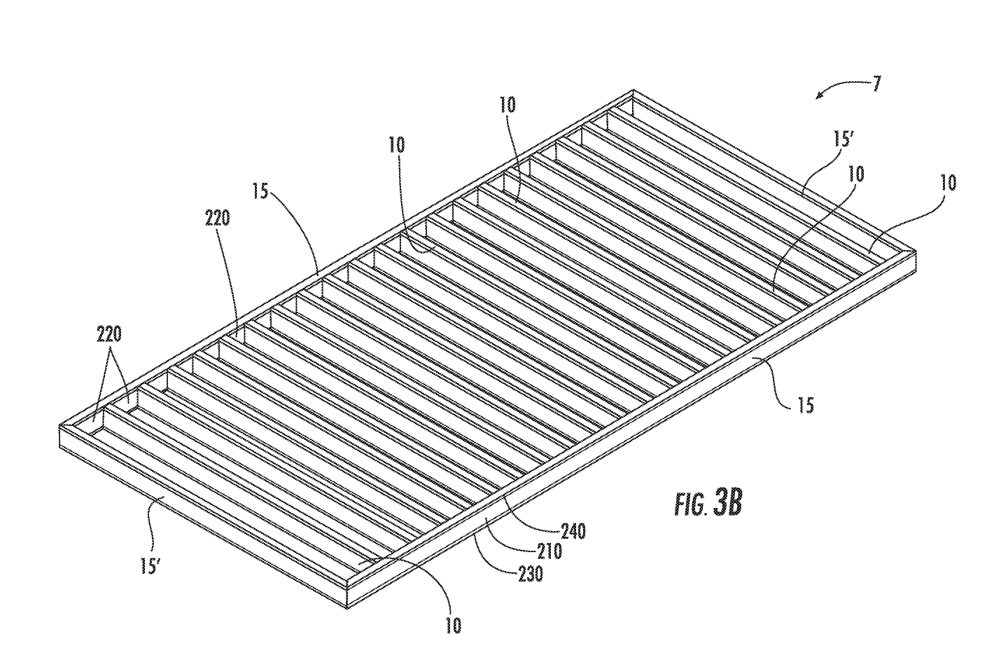

A reinforced board (e.g., a reinforced joist 10, such as a floor joist) according to a particular embodiment is shown in FIGS. 1A-1C. As may be understood from these figures and FIG. 3, the joist 10 comprises: (1) a body portion 111; and (2) two tenons 125, each of which extends from a respective end of the joist 10. In particular embodiments, the joist's body portion 111 has a substantially uniform cross section (e.g., an entirely uniform cross section) along the entire length of the joist's body portion 111.

As may be understood from FIG. 1C, which shows the cross section of the joist's body portion, the joist 10 comprises an elongated reinforcing member 100 that has a substantially Z-shaped (e.g., Z-shaped) cross section. In particular embodiments, the reinforcing member 100 is metal (e.g., steel, aluminum, or other suitable metal) although, in alternative embodiments, the reinforcing member 100 may be made of other suitable materials.

In the embodiment shown in FIG. 1C, the reinforcing member 100 comprises a substantially planar base portion 101 that is substantially parallel to (e.g., parallel to) the joist's exterior side surfaces, and that is substantially perpendicular to (e.g., perpendicular to) the joist's exterior top and bottom surfaces.

The reinforcing member 100 further includes a first extension portion 102 that, in various embodiments, is substantially planar (e.g., planar). In particular embodiments, such as the embodiment shown in FIG. 1C, the first extension portion 102: (1) extends outwardly from the top end of the reinforcing member's base portion 101; and (2) is substantially perpendicular to (e.g., perpendicular to) the reinforcing member's base portion 101. As shown in FIG. 1C, the top portion of the reinforcing member's base portion 101 and the first extension portion 102 cooperate to form a right angle that defines a recess between the sides of the right angle.

As may be understood from FIG. 1C, in particular embodiments, the reinforcing member 100 further includes a second extension portion 103 that, in various embodiments, is substantially planar (e.g., planar). In particular embodiments, such as the embodiment shown in FIG. 1C, the second extension portion 103: (1) extends outwardly from the bottom end of the reinforcing member's base portion 101; and (2) is at least substantially perpendicular to the reinforcing member's base portion 101. As shown in FIG. 1C, the bottom portion of the reinforcing member's base portion 101 and the second extension portion 103 cooperate to form a right angle that defines a recess between the sides of the right angle. In particular embodiments, the first and second extension portions 102, 103 are on opposite side of the reinforcing member's base portion 101.

In the embodiment shown in FIG. 1C, the joist 10 further comprises a first length of material 110 (e.g., a plastic material such as polystyrene or polypropylene) that, in various embodiments, is in the form of a substantially rectangular prism. In particular embodiments, such as the embodiment of FIG. 1C, the cross section of the first length of material 110 is about half as wide as the joist's body portion and is about the same height as the reinforcing member's base portion 101. Also, in particular embodiments, the first length of material 110 extends substantially the full length of (e.g., the entire length of) the joist's body portion 111.

As may be understood from FIG. 1C, the first length of material 110 is adapted to substantially mate with the structure formed by the reinforcing member 100 and the first extension portion 102. In this embodiment, an interior corner side of the first length of material is disposed within the recess defined by the reinforcing member 100 and the first extension portion 102.

In the embodiment shown in FIG. 1C, the joist 10 also comprises a second length of material 120 (e.g., a plastic material such as polystyrene or polypropylene) that, in various embodiments, is in the form of a substantially rectangular prism. In particular embodiments, such as the embodiment of FIG. 1C, the cross section of the second length of material 120 is about half as wide as the joist's body portion and is about the same height as the reinforcing member's base portion 101. Also, in particular embodiments, the second length of material 120 extends substantially the full length of (e.g., the entire length of) the joist's body portion 111.

As may be understood from FIG. 1C, the second length of material 120 is adapted to substantially mate with the structure formed by the reinforcing member 100 and the second extension portion 103. In this embodiment, an interior corner side of the second length of material 120 is disposed within the recess defined by the reinforcing member 100 and the second extension portion 103.

Turning further to FIG. 1C, in this embodiment, the joist 10 further comprises a third length of material 130 (e.g., a plastic material such as polystyrene or polypropylene) that, in various embodiments, is in the form of a substantially rectangular prism. In particular embodiments, such as the embodiment of FIG. 1C, the cross section of the third length of material 130 is about as wide (e.g., exactly as wide) as the joist's body portion. Also, in particular embodiments, the third length of material 130 extends substantially the full length of (e.g., the entire length of) the joist's body portion 111.

This third length of material 130 is mounted below: (1) the first and second lengths of material 110, 120; and (2) the second extension portion 103 of the reinforcing member 100. In particular embodiments, such as the embodiment shown in FIG. 1C, a first side edge of the third length of material 130 is substantially coplanar with (e.g., coplanar with) the outer side of the first length of material 110. Similarly, the second side edge of the third length of material 130 is substantially coplanar with the outer side of the second length of material 120. As a result, the first, second, and third lengths of material 110, 120, 130, and the reinforcing member 100 cooperate to form a structure having a substantially rectangular cross section (See FIG. 1C).

Turning again to FIG. 1C, in this embodiment, the joist 10 further comprises a fourth length of material 140 (e.g., a plastic material such as polystyrene or polypropylene) that, in various embodiments, is in the form of a substantially rectangular prism. In particular embodiments, such as the embodiment of FIG. 1C, the cross section of the fourth length of material 140 is about as wide (e.g., exactly as wide) as the joist's body portion 111. Also, in particular embodiments, the fourth length of material 140 extends substantially the full length of (e.g., the entire length of) the joist's body portion 111.

This fourth length of material 140 is mounted above: (1) the first and second lengths of material 110, 120; and (2) the first extension portion 102 of the reinforcing member 100. In particular embodiments, such as the embodiment shown in FIG. 1C, a first side edge of the fourth length of material 140 is substantially coplanar with (e.g., coplanar with) the outer side of the first length of material 110. Similarly, the second side edge of the fourth length of material 140 is substantially coplanar with the outer side of the second length of material 120. As a result, the first, second, and fourth lengths of material 110, 120, 140, and the reinforcing member 100 cooperate to form a structure having a substantially rectangular cross section. As may be understood from FIG. 1C, the first, second, third and fourth lengths of material 110, 120, 130, 140, and the reinforcing member 100 also cooperate to form a structure having a substantially rectangular cross section.

In various embodiments, the first, second, third and fourth lengths of material 110, 120, 130, 140, and the reinforcing member 100 are attached together in the arrangement shown in FIG. 1C. For example, in particular embodiments, these various components are glued together with a suitable adhesive, such as PVC glue or another suitable glue. In other embodiments, these components may be attached together using a suitable fastener, such as suitable fastening hardware.

As noted above, and as shown in FIGS. 1A-1C and FIG. 3, in various embodiments, the joist 10 comprises two tenons 125, each of which is disposed adjacent a respective end of the joist's body portion 111. In particular embodiments, such as the embodiment shown in FIGS. 1A-1C, these tenons 125 are substantially in the form of a rectangular prism and comprise: (1) an end portion of the first and second lengths of material 110, 120; and (2) an end portion of the structural support 100.

As shown in FIG. 1B, the end 150 of the base portion 101 of the structural support 100 is folded over the end of the first length of material 110, and is attached (e.g., glued) to the end of the first length of material 110 so that: (1) the end of the structural support's base portion 101 is at least substantially perpendicular to (e.g., perpendicular to) the rest of the structural support's base portion 101; and (2) the end of the structural support's base portion 101 overlaps at least a portion of the end of the first length of material 110. As described in greater detail below, in particular embodiments, this end portion of the structural support's base portion 101 (which, in various embodiments, is made of a hard metal, such as steel) may help to securely attach the joist 10 to a corresponding band joist 15.

### Second Exemplary Reinforced Board

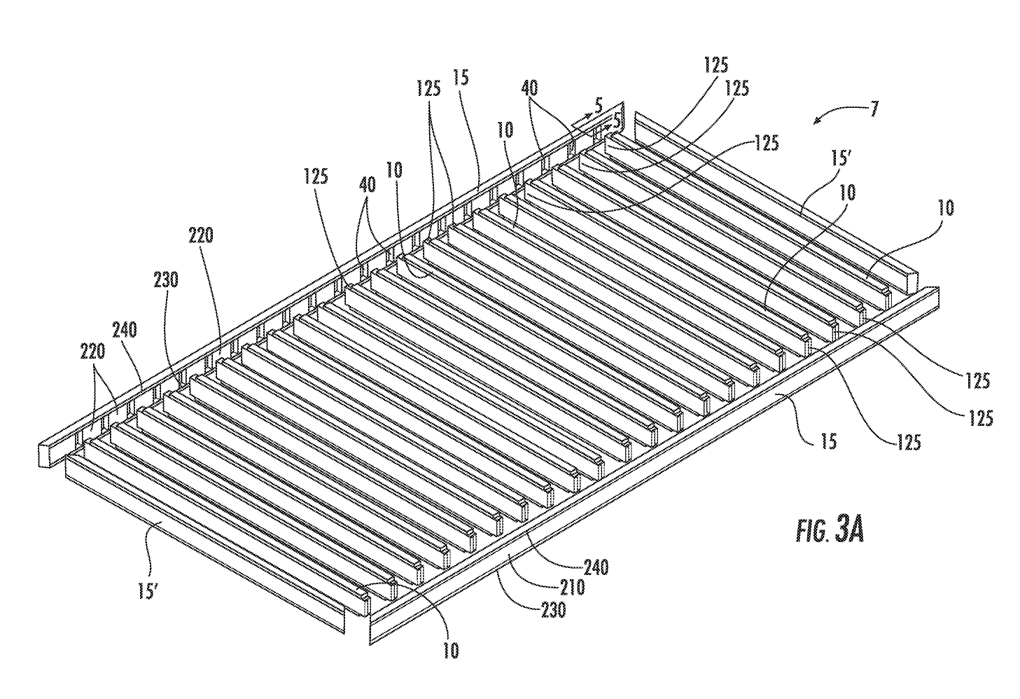

A second exemplary reinforced board (e.g., a reinforced joist, such as a band joist 15, 15¹) according to a particular embodiment is shown in FIGS. 2A-2B. A cross-section of this band joist 15, 15¹ is shown in FIG. 2B. In particular embodiments, and as shown in FIG. 3, certain embodiments of the band joist 15 (e.g., in which the joist is used as a side band joist 15) may include a plurality of mortises 40 that are dimensioned to matingly receive a tenon 125 of a respective floor joist 10. In particular embodiments, the mortises 40 are spaced evenly (e.g., every 300 mm—or other predetermined distance—on centre) along the length of the side band joist 15.

In other embodiments, such as when the band joist is used as an end band joist 15¹, the end band joist 15¹includes no mortises 40.

In particular embodiments, the band joist's body portion 211 has a substantially uniform cross section along the length of the body portion 211, except where a portion of the cross section (e.g., the second length of material 220 referenced below) has been removed to create a recess (e.g., a mortise 40) in the band joist 15 (See FIG. 3). Also, in particular embodiments, the ends of the band joist's reinforcing member 200 (which is discussed below) may extend just short of the respective ends of the band joist 15, 15¹. This allows a user to cut the ends of the band joist 15, 15¹ to a desired angle (e.g., 45 degrees), as shown in FIG. 3, without having to cut through the reinforcing member 200.

As may be understood from FIG. 2B, which shows the cross section of the band joist's body portion 211, the band joist 15, 15¹ comprises an elongated reinforcing member 200 that has a substantially U-shaped (e.g., U-shaped) cross section. In particular embodiments, the reinforcing member 200 is metal (e.g., steel, aluminum, or other suitable metal) although, in alternative embodiments, the reinforcing member 200 may be made of other suitable materials.

In the embodiment shown in FIG. 2B, the reinforcing member 200 comprises a substantially planar base portion 201 that is substantially parallel to (e.g., parallel to) the joist's exterior side surfaces, and that is substantially perpendicular to (e.g., perpendicular to) the band joist's exterior top and bottom surfaces. The reinforcing member 200 further includes a first extension portion 202 that, in various embodiments, is substantially planar (e.g., planar). In particular embodiments, such as the embodiment shown in FIG. 2B, the first extension portion 202: (1) extends outwardly from the top end of the reinforcing member's base portion 201; and is (2) substantially perpendicular to (e.g., perpendicular to) the reinforcing member's base portion 201. As shown in FIG. 2B, the top portion of the reinforcing member's base portion 201 and the first extension portion 202 cooperate to form a right angle that defines a recess between the sides of the right angle. In particular embodiments, the first and second extension portions 202, 203 are on the same side of the reinforcing member's base portion 201.

As may be understood from FIG. 2B, in particular embodiments, the reinforcing member 200 further includes a second extension portion 203 that, in various embodiments, is substantially planar (e.g., planar). In particular embodiments, such as the embodiment shown in FIG. 2B, the second extension portion 203: (1) extends outwardly from the bottom end of the reinforcing member's base portion 201; and is (2) substantially perpendicular (e.g., perpendicular) to the reinforcing member's base portion 201. As shown in FIG. 2B, the bottom portion of the reinforcing member's base portion 201 and the second extension portion 203 cooperate to form a right angle that defines a recess between the sides of the right angle.

In the embodiment shown in FIG. 2B, the band joist 15, 15¹ further comprises a first length of material 210 (e.g., a plastic material such as polystyrene or polypropylene) that, in various embodiments, is in the form of a substantially rectangular prism. In particular embodiments, such as the embodiment of FIG. 2B, the cross section of the first length of material 210 is about half as wide as the joist's body portion and is about the same height as the reinforcing member's base portion 201. Also, in particular embodiments, the first length of material 210 extends substantially the full length of (e.g., the entire length of) the joist's body portion 211.

As may be understood from FIG. 2B, the first length of material 210 is adapted to substantially mate with the structure formed by the reinforcing member 200 and the first extension portion 202. In this embodiment, a first interior corner side of the first length of material 210 is disposed within the recess defined by the base portion 201 of the reinforcing member 200 and the first extension portion 202. Similarly, a second interior corner side of the first length of material 210 is disposed within the recess defined by the base portion 201 of the reinforcing member 200 and the second extension portion 203.

In the embodiment shown in FIG. 2B, the band joist 15, 15¹ also comprises a second length of material 220 (e.g., a plastic material such as polystyrene or polypropylene) that, in various embodiments, is in the form of a substantially rectangular prism. In particular embodiments, such as the embodiment of FIG. 2B, the cross section of the second length of material 220 is about half as wide as the joist's body portion and is about the same height as the reinforcing member's base portion. Also, in particular embodiments, the second length of material 220 extends substantially the full length of (e.g., the entire length of) the joist's body portion. In other embodiments, the second length of material 220 extends the full length of the joist's body portion in the form of a plurality of sections that are separated by gaps, which are used as the joist's mortises 40 (See FIG. 3).

Turning further to FIG. 2B, in this embodiment, the band joist 15, 15¹ further comprises a third length of material 230 (e.g., a plastic material such as polystyrene or polypropylene) that, in various embodiments, is in the form of a substantially rectangular prism. In particular embodiments, such as the embodiment of FIG. 2B, the cross section of the third length of material 230 is about as wide (e.g., exactly as wide) as the joist's body portion 211. Also, in particular embodiments, the third length of material 230 extends substantially the full length of (e.g., the entire length of) the joist's body portion 211.

This third length of material 230 is mounted below: (1) the first and second lengths of material 210; and (2) the second extension portion 203 of the reinforcing member 200. In particular embodiments, such as the embodiment shown in FIG. 2B, a first side edge of the third length of material 230 is substantially coplanar with (e.g., coplanar with) the outer side of the first length of material 210. Similarly, the second side edge of the third length of material 230 is substantially coplanar with the outer side of the second length of material 220. As a result, the first, second, and third lengths of material 210, 220, 230, and the reinforcing member 200 cooperate to form a structure having a substantially rectangular cross section.

Turning again to FIG. 2B, in this embodiment, the band joist 15, 15¹ further comprises a fourth length of material 240 (e.g., a plastic material such as polystyrene or polypropylene) that, in various embodiments, is in the form of a substantially rectangular prism. In particular embodiments, such as the embodiment of FIG. 2B, the cross section of the fourth length of material 240 is about as wide (e.g., exactly as wide) as the joist's body portion 211. Also, in particular embodiments, the fourth length of material 240 extends substantially the full length of (e.g., the entire length of) the joist's body portion 211.

This fourth length of material 240 is mounted above: (1) the first and second lengths of material 210, 220; and (2) the first extension portion 202 of the reinforcing member 200. In particular embodiments, such as the embodiment shown in FIG. 2B, a first side edge of the fourth length of material 230 is substantially coplanar with (e.g., coplanar with) the outer side of the first length of material 210. Similarly, the second side edge of the fourth length of material 240 is substantially coplanar with the outer side surface of the second length of material 220. As a result, the first, second, and fourth lengths of material 210, 220, 240, and the reinforcing member cooperate to form a structure having a substantially rectangular cross section, as shown in FIG. 2B. The first, second, third and fourth lengths of material 210, 220, 230, 240, and the reinforcing member 200 also cooperate to form a structure having a substantially rectangular cross section.

In various embodiments, the first, second, third and fourth lengths of material 210, 220, 230, 240, and the reinforcing member 200 are attached together in the arrangement shown in FIG. 2B. For example, in particular embodiments, these various components are glued together with a suitable adhesive, such as PVC glue. In other embodiments, these components may be attached together using one or more suitable fasteners, such as suitable fastening hardware.

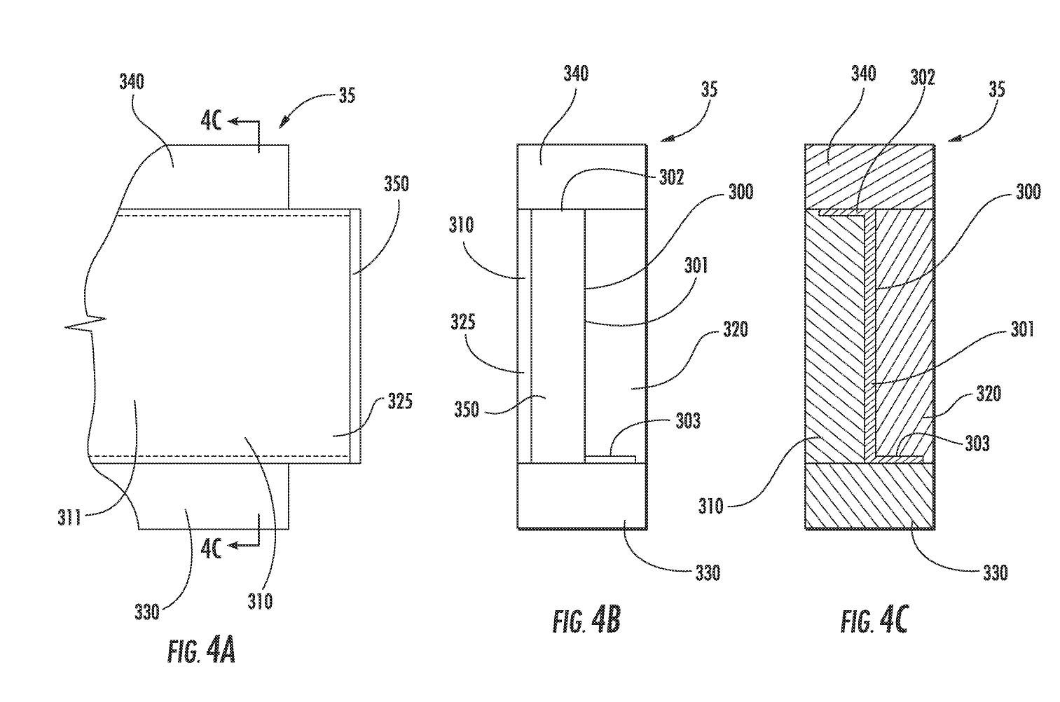

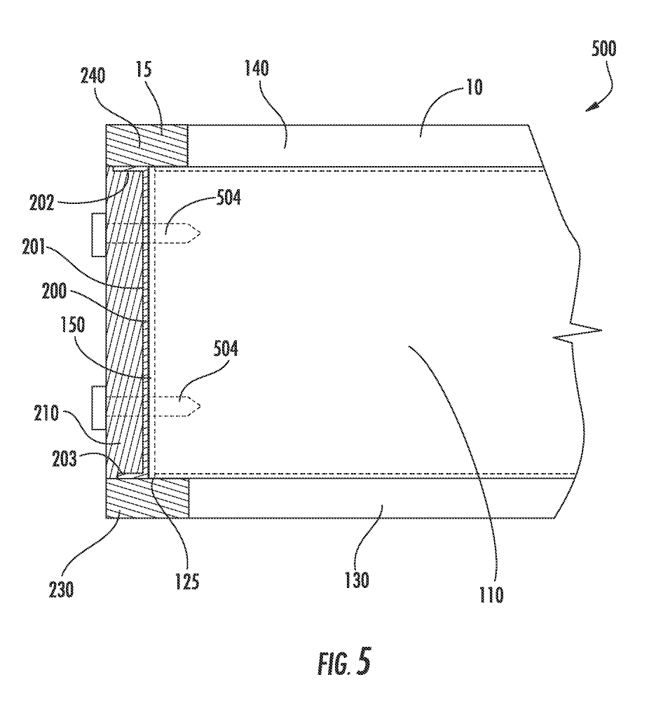

FIGS. 4A-4C show a slightly modified version of the floor joists 10 described above. In this embodiment, the joist 35 (which is particularly suitable for use as a ceiling joist) comprises: (1) a body portion 311; and (2) two tenons 325, each of which extends from a respective end of the ceiling joist 35. In particular embodiments, the ceiling joist's body portion 311 has a substantially uniform cross section (e.g., an entirely uniform cross section) along the entire length of the ceiling joist's body portion 311. Aside from various dimensional differences, the full cross section of the ceiling joist 35 is generally the same as the full cross section of the floor joist 10 described above (See FIGS. 1A-1C and FIGS. 4A-4C). For example, like the floor joist 10 of FIGS. 1A-1C, the ceiling joist 35 of FIGS. 4A-4C comprises a reinforcing member 300, and first, second, third, and fourth lengths of material 310, 320, 330, 340 that are dimensioned, assembled and attached together generally as described above in regard to the floor joists 10 of FIGS. 1A-1C.

### Exemplary Deck Frame Including Exemplary Reinforced Boards

FIGS. 3A and 3B show an exemplary deck frame 7 that includes the exemplary floor and band joists 10, 15, 15¹ described above. As may be understood from this figure, the deck frame 7 includes a deck band and a plurality of (e.g., two) floor joists 10. The deck band includes a plurality of side band joists 15, and two end band joists 15¹. The side band joists 15 are structured as described above, and each defines a plurality of substantially vertically oriented mortises 40 on its interior surface. These mortises 40 are spaced evenly (e.g., every 300 mm on center) along the length of the side band joists 15.

As noted above, each floor joist 10 comprises two tenons 125, each of which extends from a respective end of the joist 10. These tenons 125 are substantially in the form of a rectangular prism, and the body portion 101 of the joist's reinforcing member 100 (which, in various embodiments, is made of steel) folds over and is attached to the end of the tenons 125.

To assemble the deck frame, an individual first attaches a first side of each of: (1) the deck frame's floor joists 10; and (2) the deck frame's end band joists 15¹ to one of the deck frame's side band joists 15 (or to one co-linear set of side band joists 15 if multiple side band joists are used to define one side of the deck band). As noted above, in the embodiment shown in FIG. 3, the outer ends of the various band joists are cut to form 45 degree angles. To attach the deck frame's end band joists 15¹ to one of the deck frame's side band joists 15, a user simply: (1) aligns respective end surfaces of the band joists 15, 15¹ (e.g., so that the respective perimeters of the end surfaces align with each other); and (2) attaches the aligned ends of the band joists 15, 15¹ together using suitable hardware and/or adhesives.

To attach one of the deck frame's floor joists 10 to one of the deck frame's side band joists 15, the user inserts the floor band joist's tenon 125 into a respective mortise 40 within the side band joist 15, and affixes the tenon 125 in place within the mortise 40 (e.g., by using suitable hardware and/or adhesives).

For example, to attach a first side of one of the deck frame's floor joists 10 to one of the deck frame's side band joists 15, the user first coats the floor joist's tenon 125 with PVC glue and inserts the tenon 125 into a mortise 40 defined by the first side band joist 15 as shown in FIG. 5. The user then drives a self-tapping screw 504 (or other suitable fastener) through: (1) the outer surface of the first side band; (2) the base portion 201 of the first side band joist's reinforcing member 200; and (3) the end portion 150 of the floor joist's reinforcing member (which, as shown in FIG. 1B, covers at least a portion of the end of the floor joist's first length of material 110). The user then continues to drive the self-tapping screw into the interior of the floor joist's first length of material 110). Once this process is complete, the floor joist 10, side band joist 15, and screws 504 are situated as shown in FIG. 5. The user may then repeat this process with another fastener (e.g., another self-tapping screw 504) to further secure the floor joist 10 to the side band joist 15.

After the individual attaches a first side of each of: (1) the deck frame's floor joists 10; and (2) the deck frame's end band joists 15¹ to one or more of the deck frame's side band joists 15 as described above, the individual attaches, in the manner described above, a second side of each of: (1) the deck frame's floor joists 10; and (2) the deck frame's end band joists 15¹ to another one of the deck frame's side band joists 15 (or to one co-linear set of side band joists 15 if multiple side band joists are used to define one side of the deck band). This step typically completes the deck frame assembly process.

In light of the discussion above, it should be understood that, in various embodiments, when the deck frame 7 is entirely assembled, the reinforcing members 100, 200 of the various joists 10, 15, 15¹ are at least substantially encased (e.g., entirely encased) in other components of the joists 10, 15, 15¹ (e.g., in the joists' respective first, second, third, and fourth lengths of material which may, for example, be polystyrene). This may, in particular embodiments, serve to at least substantially insulate the reinforcing members 100, 200 from the atmosphere. This may reduce the possibility that the reinforcing members 100, 200 will rust or otherwise degrade over time.

### Alternative Board Structures

It should be understood that the structure of the various reinforced board structures described above may vary in other embodiments of the invention. For example, the relative sizes of the various components of the board may be different than those described above. For example, the joist 35 of FIG. 4C (which is discussed above) is a relatively shorter and wider version of the joist 10 shown in FIG. 1C.

It should also be understood that the shape, position, and relative size of the reinforcing member may vary among different embodiments of the invention. For example, the reinforcing member may be substantially in the form of an I, an L, or an 0.

Similarly, although various embodiments of the reinforced boards are described above as having plastic first, second, third, and fourth lengths of material, it should be understood that, in other embodiments, these components may be made of any other suitable material, such as wood or fiberglass. Also, although the first, second, third, and fourth lengths of material are described above as being in the form of at least substantially rectangular prisms, these components can be of any other suitable shape.

In addition, it should be understood, in light of this disclosure, that the board structures described herein may be used in the context of a variety of different building materials, such as posts, beams, and other types of joists.

### CONCLUSION

Many modifications and other embodiments of the invention will come to mind to one skilled in the art to which this invention pertains having the benefit of the teachings presented in the foregoing descriptions and the associated drawings. For example, as will be understood by one skilled in the relevant field in light of this disclosure, the invention may take form in a variety of different mechanical and operational configurations. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for the purposes of limitation.

1. A reinforced board having an exterior surface, said reinforced board comprising:
(A) an elongated structural support that extends longitudinally within an interior of said reinforced board, said elongated structural support comprising:
1. a substantially planar base portion that defines a first plane; and
2. a substantially planar extension portion that is disposed adjacent said base portion and that defines a second plane, said second plane being substantially perpendicular to said first plane;
(B) a first length of plastic material having a substantially rectangular cross section, said first length of plastic material extending longitudinally along a length of said reinforced board and defining a first, substantially planar exterior surface and a second, substantially planar exterior surface, said first exterior surface being substantially perpendicular to said second exterior surface, wherein:
said first length of plastic material is disposed in a substantially mating relationship with said elongated structural support so that:
1. said first exterior surface of said first length of plastic material is disposed immediately adjacent, and substantially parallel to, said base portion of said structural support, and
2. said second exterior surface of said first length of plastic material is disposed immediately adjacent, and substantially parallel to, said extension portion of said structural support.

2. The reinforced board of claim 1, wherein:
said elongated structural support is metal;
said reinforced board comprises at least one tenon;
said elongated structural support extends through an interior portion of said tenon, and at least partially extends around an end of said tenon.

3. The reinforced board of claim 2, wherein:
a particular portion of said elongated structural support is folded over said end portion of said first length of plastic material so that said particular portion of said elongated structural support is substantially parallel to, and attached adjacent, said end portion of said tenon.

4. The reinforced board of claim 1, wherein:
said reinforced board further comprises a second length of plastic material having a substantially rectangular cross section, said second length of plastic material extending longitudinally along a length of said reinforced board and defining a third, substantially planar exterior surface and a fourth, substantially planar exterior surface, said third exterior surface being substantially perpendicular to said fourth exterior surface, and
said second length of plastic material is positioned so that said third exterior surface is disposed immediately adjacent, and substantially parallel to, said base portion of said structural support.

5. The reinforced board of claim 4, wherein:
said first and second lengths of plastic material are disposed on opposite sides of said base portion of said elongated structural support.

6. The reinforced board of claim 5, wherein:
said reinforced board further comprises a third length of plastic material having a substantially rectangular cross section, said third length of plastic material extending longitudinally along a length of said reinforced board and defining a fifth, substantially planar exterior surface and a sixth, substantially planar exterior surface, said sixth exterior surface being substantially perpendicular to said fifth exterior surface, and
said third length of plastic material is positioned so that said fifth exterior surface is disposed immediately adjacent, and substantially parallel to, said extension portion of said structural support.

7. The reinforced board of claim 6, wherein:
said first and third lengths of plastic material are disposed on opposite sides of said extension portion of said structural support.

8. The reinforced board of claim 7, wherein:
said structural support and said first, second, and third lengths of plastic material cooperate to form a structure having a substantially rectangular cross section.

9. The reinforced board of claim 8, wherein:
said structural support is a metal support.

10. The reinforced board of claim 8, wherein:
said base portion of said elongated structural support comprises a first lateral side and a second lateral side;
said substantially planar extension portion is a first substantially planar extension portion and is disposed adjacent said first lateral side of said base portion; and
said structural support comprises a second substantially planar extension portion that is disposed adjacent said second lateral side of said base portion.

11. The reinforced board of claim 10, wherein:
said reinforced board further comprises a fourth length of plastic material having a substantially rectangular cross section, said fourth length of plastic material extending longitudinally along a length of said reinforced board and defining a seventh, substantially planar exterior surface and an eighth, substantially planar exterior surface, said eighth exterior surface being substantially perpendicular to said seventh exterior surface, and
said fourth length of plastic material is disposed so that said seventh exterior surface is disposed immediately adjacent, and substantially parallel to, said second extension portion of said structural support.

12. The reinforced board of claim 11, wherein:
said structural support and said first, second, third, and fourth lengths of plastic material cooperate to form a structure having a substantially rectangular cross section.

13. The reinforced board of claim 12, wherein a cross section of said structural support is substantially Z-shaped.

14. The reinforced board of claim 12, wherein a cross section of said structural support is substantially U-shaped.

15. The reinforced board of claim 12, wherein said first, second, third, and fourth lengths of plastic material are each attached to said structural support.

16. The reinforced board of claim 12, wherein said first, second, third, and fourth lengths of plastic material are each glued to said structural support.

17. A reinforced board having an exterior surface and an interior portion, said reinforced board comprising:
A. an elongated structural support that extends longitudinally within said interior portion of said reinforced board; and
B. a plurality of lengths of material that each have a substantially rectangular cross section and that each extend longitudinally along a particular length of said reinforced board; wherein:
said plurality of lengths of material are at least substantially matingly attached together in at least a substantially circumferential manner about said elongated structural support to form said reinforced board.

18. The reinforced board of claim 17, wherein:
said plurality of lengths of material are plastic lengths of material.

19. The reinforced board of claim 17, wherein:
said structural support and said plurality of lengths of material cooperate to form a structure having a substantially rectangular cross section.

20. The reinforced board of claim 19, wherein said structural support has a substantially Z-shaped cross-section.

21. The reinforced board of claim 20, wherein said structural support is a metal structural support.

22. The reinforced board of claim 21, wherein said plurality of lengths of material are plastic lengths of material.

23. The reinforced board of claim 19, wherein said structural support has a substantially U-shaped cross-section.

24. The reinforced board of claim 23, wherein said structural support is a metal structural support.

25. The reinforced board of claim 24, wherein said plurality of lengths of material are plastic lengths of material.

26. The reinforced board of claim 17, wherein:
said structural support is metal;
said reinforced board comprises at least one tenon; and
said elongated structural support extends through an interior portion of said tenon, and at least partially extends around an end of said tenon.

27. The reinforced board of claim 26, wherein:
a particular portion of said elongated structural support is folded over said end portion of said tenon so that said particular portion of said elongated structural support is substantially parallel to, and attached adjacent, said end portion of said tenon.

28. The reinforced board of claim 27, wherein said plurality of lengths of material are plastic lengths of material.
